(19) United States
(12) Patent Application Publication
(10) Pub. No.: US 2023/0361379 A1
(43) Pub. Date: Nov. 9, 2023

(54) BATTERY MODULE HAVING COOLING STRUCTURE USING INSULATING OIL, AND BATTERY PACK AND VEHICLE COMPRISING SAME

(71) Applicants: LG Energy Solution, Ltd., Seoul (KR); RENAULT S.A.S., Boulogne Biliancourt (FR)

(72) Inventors: Eun-Ah Ju, Daejeon (KR); Hyeon-Ki Yun, Daejeon (KR); Jeong-O Mun, Daejeon (KR); Guenter Tannenberger, Pobenhausen (DE); Jan Janke, Brackenheim (DE); Uwe Harasztosi, Neckarsulm (DE)

(21) Appl. No.: 18/029,841

(22) PCT Filed: Nov. 15, 2021
(86) PCT No.: PCT/KR2021/016668

§ 371 Date: Mar. 31, 2023

(30) Foreign Application Priority Data
Nov. 16, 2020 (KR) 10-2020-0153016

(51) Int. Cl. H01M 10/613; H01M 10/6551; H01M 10/653; H01M 50/507

(52) U.S. Cl. CPC H01M 10/653; H01M 10/613; H01M 10/6551; H01M 50/507; H01M 50/547

(57) ABSTRACT

A battery module including: a sub-module, the sub-module including a cell stack including a plurality of battery cells and a plurality of cooling fins located between adjacent battery cells, a front bus bar frame assembly coupled to a first side of the cell stack in a longitudinal direction of the cell stack, and a rear bus bar frame assembly coupled to a second side of the cell stack in the longitudinal direction of the cell stack; a housing accommodating the sub-module; a front sealing plate covering an opening on a first side of the housing in a longitudinal direction of the housing and including an insulating oil inlet; and a rear sealing plate covering an opening on a second side of the housing in the longitudinal direction of the housing and including an insulating oil outlet.

### CROSS-REFERENCE TO RELATED APPLICATIONS

The present application is a US national phase of international application No. PCT/KR2021/016668 filed on Nov. 15, 2021, and claims priority to Korean Pat. Application No. 10-2020-0153016 filed on Nov. 16, 2020, the disclosures of which are incorporated by reference as if fully set forth herein.

### TECHNICAL FIELD

The present disclosure relates to a battery module having a cooling structure using insulating oil and a battery pack and a vehicle including the battery module, and more particularly, to a battery module having a structure in which insulating oil introduced into a housing flows through a space between an edge of the battery cells and the housing to cool the battery cells, and a battery pack and a vehicle including the battery module. BACKGROUND

In the case of a battery module using an indirect water cooling method using cooling water, there is a limit to its cooling performance because cooling water does not directly contact a battery cell but indirectly contacts the battery cell through a housing which accommodates the battery cell. Also, because a cooling device such as a separate heat sink should be provided outside the housing to form a passage for cooling, a volume of the battery module is inevitably increased, which may cause loss in terms of energy density.

There is a need to develop a battery module having a cooling structure in which insulating oil for cooling may be directly introduced into a housing and may directly contact a battery cell to solve the problems associated with the indirect water cooling method.

In the case of a battery module having a direct cooling structure using insulating oil, it is very important to secure a fluid passage structure for efficient cooling, and maintain airtightness so that insulating oil does not leak to the outside of a housing and an end plate.

### SUMMARY

The present disclosure is designed to solve the problems of conventional batter modules, and therefore the present disclosure is directed to securing a path through which insulating oil introduced into a housing passes through a bus bar frame assembly, smoothly moves toward a cell stack, and smoothly flows in a longitudinal direction of the battery module.

However, the technical purpose to be solved by the present disclosure is not limited to the above, and other objectives not mentioned herein will be clearly understood by one of ordinary skill in the art from the following disclosure.

In one aspect of the present disclosure, there is provided a battery module including: a sub-module including a cell stack including a plurality of battery cells and cooling fins located between adjacent battery cells, a front bus bar frame assembly coupled to a side of the cell stack in a longitudinal direction of the cell stack assembly, and a rear bus bar frame assembly coupled to the other side of the cell stack in the longitudinal direction of the cell stack; a housing in which the sub-module is accommodated; a front sealing plate covering an opening formed on a side of the housing in a longitudinal direction of the housing and including an insulating oil inlet; and a rear sealing plate covering an opening formed on the other side of the housing in the longitudinal direction of the housing and including an insulating oil outlet.

Each of the cooling fins may include: a body contact portion located between adjacent battery cells; and an edge cover portion bent at any one of an upper end and a lower end of the body contact portion to cover a respective edge of the adjacent battery cell.

Each of the front bus bar frame assembly and the rear bus bar frame assembly may include a plurality of insulating oil holes formed at positions corresponding to insulating oil passages formed between the housing and an edge of the battery cells and between the edge cover portion and an edge of the battery cells.

Insulating oil introduced through the insulating oil inlet into the housing may pass through the insulating oil holes formed in the front bus bar frame assembly and may be introduced into the insulating oil passage.

The insulating oil passing through the insulating oil passage may pass through the insulating oil holes formed in the rear bus bar frame assembly, and may be discharged from the housing to the outside through the insulating oil outlet.

Each of the front bus bar frame assembly and the rear bus bar frame assembly may further include guide ribs formed at an upper end and a lower end, respectively, and extending toward the cell stack.

Each of the cooling fins may further include a pair of fixing portions each having a shape corresponding to the guide rib, formed on both end portions of the edge cover portion in a longitudinal direction of the edge cover portion, and each coupled to the guide rib.

The battery module may further include a pair of terminal assemblies each including an external terminal located outside the front sealing plate and the rear sealing plate, respectively, and a pair of studs passing through the front sealing plate and the rear sealing plate, respectively, and configured to electrically connect the external terminal to the battery cells.

The front bus bar frame assembly may include: a bus bar frame; a plurality of bus bars fixed to the bus bar frame, and connected to an electrode lead of the battery cell located at an outermost position from among the battery cells provided in the cell stack; and a pair of internal terminals each fixed to the bus bar frame, and connected to an electrode lead of the battery cell located at an outermost position from among the battery cells provided in the cell stack.

Each of the terminal assemblies may further include a terminal spacer inserted into a terminal hole formed in the front sealing plate and the rear sealing plate, respectively, wherein the stud is fixed to the internal terminal and passes through the terminal spacer.

Each of the terminal assemblies may further include a fastening nut fastened to the stud passing through the terminal spacer and the external terminal and configured to closely fix the external terminal to the terminal spacer.

Each of the terminal assemblies may further include a first O-ring covering an outer circumferential surface of the terminal spacer and located between an inner surface of the front sealing plate and the rear sealing plate, respectively, and the internal terminal.

The stud may be press-fitted by passing through the internal terminal, wherein the terminal assembly further includes a second O-ring located around the stud and located between the internal terminal and the bus bar frame.

In another aspect of the present disclosure, there are also provided a battery pack and a vehicle including the battery module.

According to an aspect of the present disclosure, insulating oil introduced into a housing may pass through a bus bar frame assembly, may smoothly move toward a cell stack assembly, and may smoothly flow in a longitudinal direction of a battery module in the housing. Also, according to an aspect of the present disclosure, leakage of insulating oil flowing inside a module housing may be effectively prevented.

### BRIEF DESCRIPTION OF DRAWINGS

The accompanying drawings illustrate a preferred embodiment of the present disclosure and together with the foregoing disclosure, serve to provide further understanding of the technical features of the present disclosure, and thus, the present disclosure is not construed as being limited to the drawing.

FIG. 1 is a perspective view of a battery module according to an embodiment of the present disclosure.

FIG. 2 is an exploded perspective view of the battery module according to an embodiment of the present disclosure.

FIG. 3 is a cross-sectional view along line A-A′ of FIG. 1.

FIG. 4 is of the battery module of FIG. 1 when a front end plate and a front sealing plate are removed from the batter module.

FIGS. 5 and 6 are illustrations of a flow of insulating oil for cooling.

FIGS. 7 and 8 are illustrations of a coupling relationship between a cooling fin and a battery cell according to the present disclosure.

FIG. 9 is a perspective view of a cooling fin according to the present disclosure.

FIG. 10 is an illustration of a coupling structure between a bus bar frame assembly and a cooling fin according to the present disclosure.

FIGS. 11 and 12 are illustrations of a terminal assembly according to the present disclosure.

### DETAILED DESCRIPTION

Hereinafter, preferred embodiments of the present disclosure will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present disclosure on the basis of the principle that the inventor is allowed to define terms appropriately for the best explanation. Therefore, the description proposed herein is just a preferable example for the purpose of illustrations only, not intended to limit the scope of the disclosure, so it should be understood that other equivalents and modifications could be made thereto without departing from the scope of the disclosure.

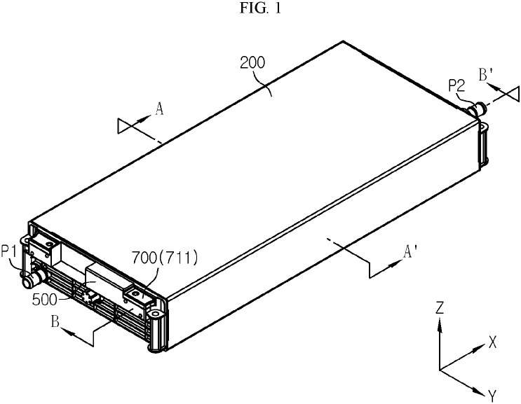

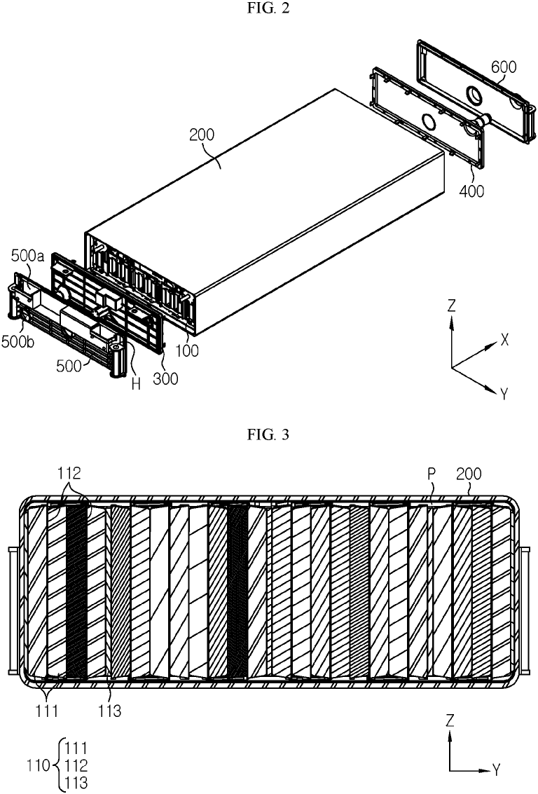

As illustrated in FIGS. 1 and 2, a battery module according to an embodiment of the present disclosure includes a sub-module 100, a housing 200, a front sealing plate 300, a rear sealing plate 400, and a pair of terminal assemblies 700, and may further include a front end plate 500 and a rear end plate 600.

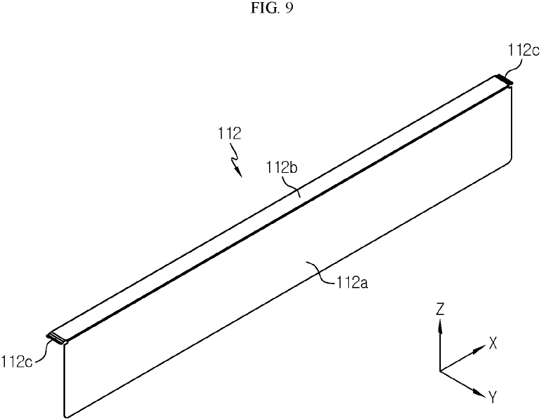

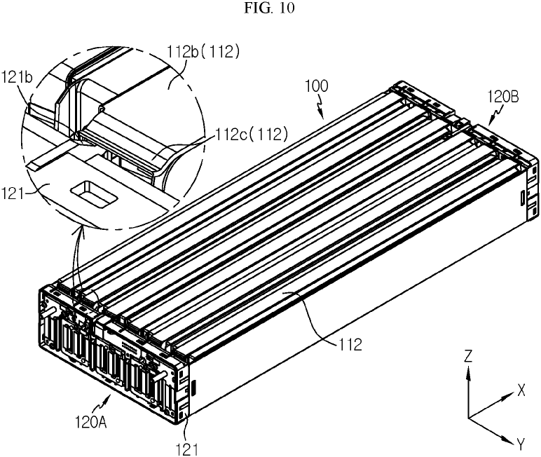

As illustrated in FIGS. 2 through 9, the sub-module 100 includes a cell stack 110, a front bus bar frame assembly 120A, and a rear bus bar frame assembly 120B.

The cell stack 110 includes a plurality of battery cells 111 and a plurality of cooling fins 112 located between adjacent battery cells 111, and may further include at least one buffer pad 113 located between adjacent battery cells 111. The battery cells 111, the cooling fins 112, and the buffer pads 113 are stacked upright in a direction perpendicular to the ground (surface parallel to an X-Y plane) to constitute one cell stack 110.

The battery cells 111 may be a pouch-type battery cell including a pair of electrode leads 111a drawn out in opposite directions in a longitudinal direction (direction parallel to an X-axis).

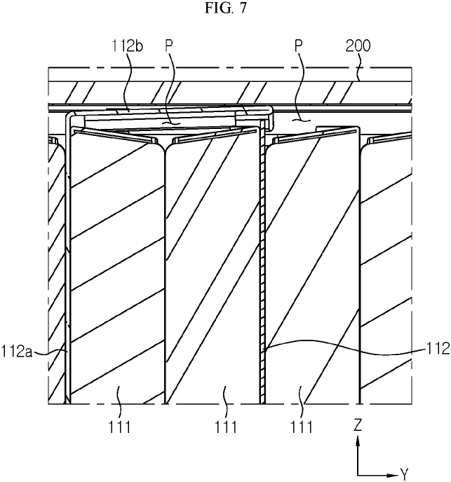

As illustrated in FIGS. 7 through 9, the cooling fin 112 includes a body contact portion 112a located between adjacent battery cells 111 and an edge cover portion 112b bent at any one of an upper end and a lower end of the body contact portion 112a to cover an edge of the respective battery cell 111. Edges of the battery cell 111 refer to both side surfaces of a body of the battery cell 111 in a width direction, that is, in a height direction (direction parallel to a Z-axis) of the battery module. Also, the cooling fin 112 may further include a pair of fixing portions 112c formed on both end portions of the edge cover portion 112b in a longitudinal direction (direction parallel to the X-axis) of the edge cover portion 112b.

The body contact portion 112a is located between bodies of a pair of adjacent battery cells 111 and directly contacts the bodies of the battery cells 111. The body contact portion 112a is configured to rapidly conduct heat generated from a body of the battery cells 111, that is, a region where an electrode assembly (not shown) is accommodated, in a width direction of the cooling fin 112, that is, the height direction (direction parallel to the Z-axis) of the battery module, toward the edge cover portion 112b. As such, the heat conducted toward the edge cover portion 112b moves in a longitudinal direction (direction parallel to the X-axis) of the battery module due to insulating oil flowing through an insulating oil passage P formed between the edge of the battery cell 111 and the edge cover portion 112b and is discharged to the outside of the battery module.

The edge cover portion 112b may not only form the insulating oil passage P as described above but may also absorb the external impact when the cell stack 110 moves in a vertical direction (direction parallel to the Z-axis) in the module housing 200 in response to an external impact.

The fixing portion 112c has a shape corresponding to that of a guide rib 121b described below. The fixing portion 112c may be coupled to the guide rib 121b, to guide fastening between the bus bar frame assembly 120A, 120B and the cell stack 110 including the cooling fins 112.

The buffer pad 113 may be located between adjacent battery cells 111 and may absorb volume expansion according to swelling of the battery cells 111.

The front bus bar frame assembly 120A and the rear bus bar frame assembly 120B may be coupled to opposite sides of the cell stack 110 in a longitudinal direction of the cell stack 110 to electrically connect the plurality of battery cells 111. The front bus bar frame assembly 120A and the rear bus bar frame assembly 120B have substantially the same structure except that the front bus bar frame assembly 120A includes an internal terminal 123 and the rear bus bar frame assembly 120B does not include the internal terminal 123. Accordingly, a detailed description of a structure of the rear bus bar frame assembly 120B will be omitted, and a structure of the front bus bar frame assembly 120A will be mainly described.

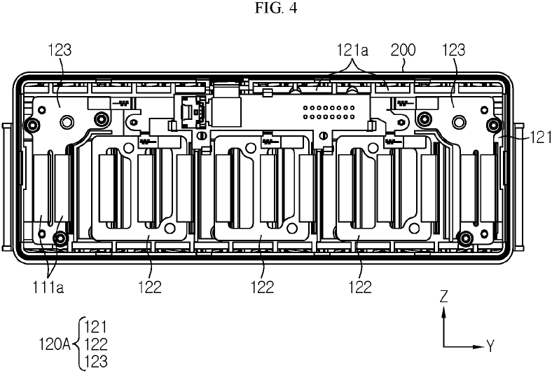

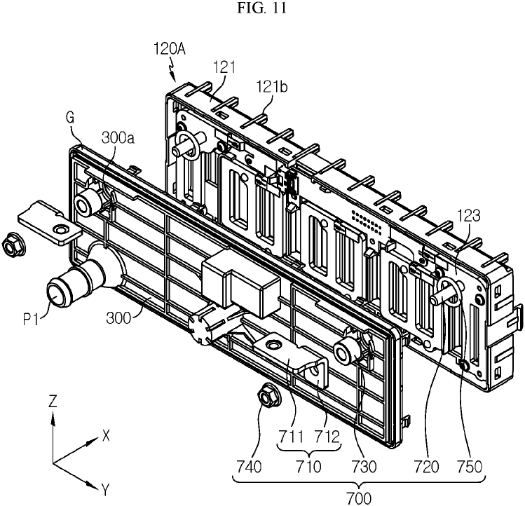

As illustrated in FIGS. 4 through 10, the front bus bar frame assembly 120A includes a bus bar frame 121, a plurality of bus bars 122, and a pair of internal terminals 123. The bus bar frame 121 covers a side of the cell stack 110 in the longitudinal direction (direction parallel to the X-axis) of the cell stack 110.

The bus bar frame 121 includes a plurality of insulating oil holes 121a. The insulating oil hole 121a functions as a path through which insulating oil introduced through an inlet P1 provided at the front sealing plate 300 into the housing 200 may pass through the bus bar frame 121 and may be introduced into the cell stack 110.

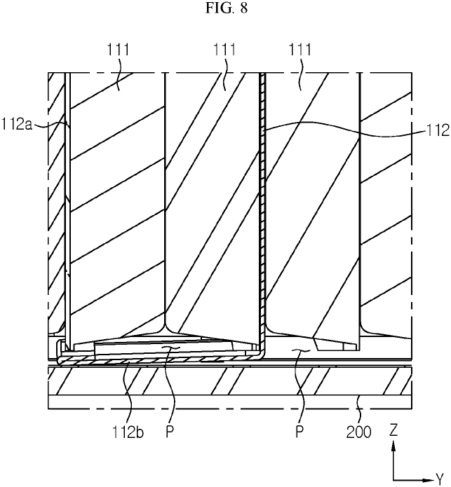

As illustrated in FIGS. 7 and 8, the insulating oil passage P is formed between the housing 200 and an edge of the battery cells 111, and between the edge cover portion 112b and an edge of the battery cells 111. Accordingly, the insulating oil hole 121a is formed at a position corresponding to the insulating oil passage P formed between the housing 200 and the edge of the battery cells 111 and between the edge cover portion 112b of the cooling fin 112 and the edge of the battery cells 111.

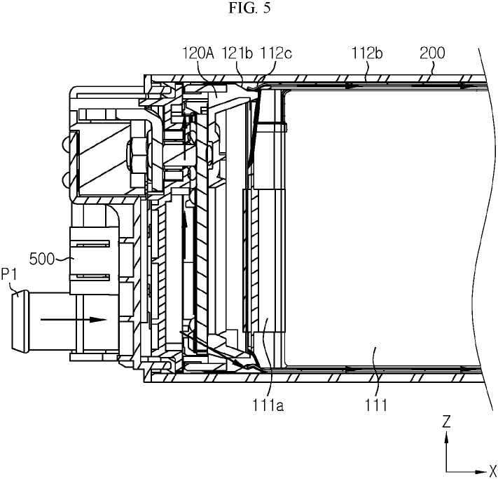

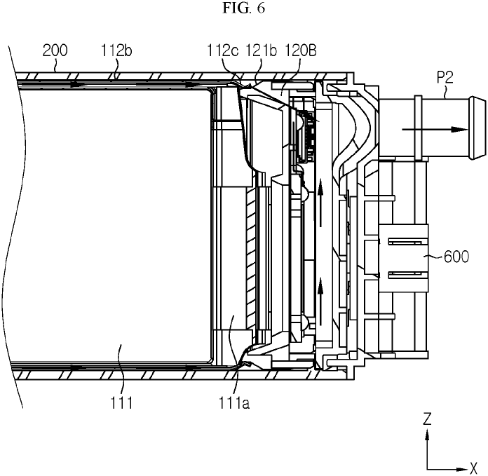

Insulating oil introduced through the insulating oil hole 121a formed in the front bus bar frame assembly 120A into the cell stack assembly 110 moves in the direction of the arrow in FIGS. 5 and 6 through the insulating oil passage P toward the rear bus bar frame assembly 120B. The insulating oil moving toward the rear bus bar frame assembly 120B is introduced through the insulating oil hole 121a formed in the rear bus bar frame 120B into the rear sealing plate 400, and is discharged to the outside of the battery module through an outlet P2 provided at the rear sealing plate 400. In this process, the insulating oil directly contacts the electrode lead 111a of the battery cells 111, and indirectly contacts a body of the battery cells 111, to cool the battery cells 111.

The bus bar 122 is fixed to the bus bar frame 121, and is coupled to the electrode lead 111a drawn out through a lead slit formed in the bus bar frame 121 to electrically connect the plurality of battery cells 111.

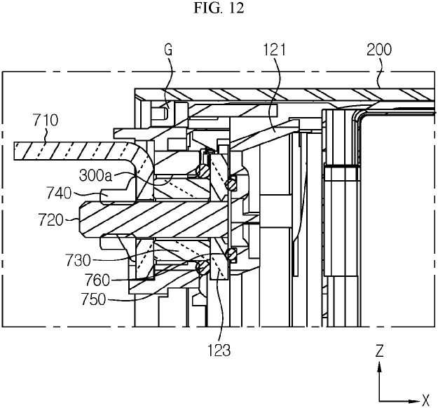

The internal terminal 123 is fixed to the bus bar frame 121, and is coupled to the electrode lead 111a of the battery cell 111 located at an outermost position from among the battery cells 111 provided in the cell stack 110. The internal terminal 123 functions as a high-potential terminal. The internal terminal located on a side of the bus bar frame 121 in a longitudinal direction of the bus bar frame 121 functions as a positive electrode high-potential terminal, and the internal terminal 123 located on the other side of the bus bar frame 121 in the longitudinal direction of the bus bar frame 121 functions as a negative electrode high-potential terminal. The internal terminal 123 is electrically connected to an external terminal 710 described below (see FIGS. 11 and 12).

As illustrated in FIGS. 5 through 10, the bus bar frame 121 of the front bus bar frame assembly 120A and the bus bar frame 121 of the rear bus bar frame assembly 120B include a plurality of guide ribs 121b formed at an upper end and a lower end in the longitudinal direction (direction parallel to a Y-axis). The guide rib 121b extends toward the cell stack assembly 110. The guide rib 121b is formed at a position corresponding to the fixing portion 112c of the cooling fin 112.

As described above, the fixing portions 112c having a shape corresponding to the guide ribs 121b are formed on both end portions of the edge cover portion of the cooling fin 112 in the longitudinal direction (direction parallel to the X-axis) of the edge cover portion 112b. A movement of the cooling fin 112 in the vertical direction (direction parallel to the Z-axis) and the longitudinal direction (direction parallel to the X-axis) is limited by the guide rib 121b and the fixing portion 112c. Accordingly, when the front bus bar frame assembly 120A and the rear bus bar frame assembly 120B are coupled to the cell stack assembly 110, a coupling position may be guided, thereby increasing assembly convenience.

As illustrated in FIGS. 1 through 6, the sub-module 100 including the cell stack 110, the front bus bar frame assembly 120A, and the rear bus frame assembly 120B is accommodated in the housing 200. The housing 200 has a shape in which opposite sides of the housing 200 in a longitudinal direction (direction parallel to the X-axis) are open.

As illustrated in FIGS. 5, 6, 11, and 12, the front sealing plate 300 covers an opening on a side of the housing 200 in the longitudinal direction (direction parallel to the X-axis) of the housing 200. The front sealing plate 300 includes the insulating oil inlet P1 through which insulating oil is introduced. A gasket G may be located between an edge surface of the front sealing plate 300 and an inner surface of the module housing 200 (see FIG. 12) to prevent leakage of insulating oil.

The front sealing plate 300 includes a pair of terminal holes 300a through which a component for electrical connection between the external terminal 710 described below and the internal terminal 123 provided in the front bus bar frame assembly 120A may pass. The terminal hole 300a is formed at a position corresponding to the internal terminal 123.

As illustrated in FIG. 6, the rear sealing plate 400 covers an opening on the other side of the housing 200 in the longitudinal direction (direction parallel to the X-axis) of the housing 200, and includes the insulating oil outlet P2 through which insulating oil is discharged. As in the front sealing plate 300, a gasket G may be located between an edge surface of the rear sealing plate 400 and an inner surface of the module housing 200 to prevent leakage of insulating oil.

The front sealing plate 300 and the rear sealing plate 400 may be formed of an insulating resin for electrical insulation.

As illustrated in FIGS. 11 and 12, one of the pair of terminal assemblies 700 includes the external terminal 710 located outside the front sealing plate 300 and a stud 720 configured to electrically connect the external terminal 710 to the battery cell 111. The stud 720 is fixed to the internal terminal 123. The stud 720 may pass through the internal terminal 123 and may be fixed to the internal terminal 123 by using a press-fitting method. The stud 720 fixed to the internal terminal 123 is drawn outward through the terminal hole 300a formed in the front sealing plate 300 and is coupled to the external terminal 710.

The terminal assembly 700 may further include a terminal spacer 730 having a ring shape and inserted into the terminal hole 300a formed in the front sealing plate 300. The terminal spacer 730 may be formed of a metal material. When the terminal spacer 730 is provided, the stud 720 passes through the terminal pacer 730.

The terminal assembly 700 may further include a fastening nut 740 for fastening the external terminal 710 to the stud 720. The fastening nut 740 is fastened to the stud 720 passing through the terminal spacer 730 and a fastening portion 712 of the external terminal 710, to closely fix the fastening portion 712 of the external terminal 710 to the terminal spacer 730. Accordingly, the internal terminal 123 and the external terminal 710 are electrically connected to each other through the terminal spacer 730.

The terminal assembly 700 may further include a first O-ring 750 covering an outer circumferential surface of the terminal spacer 730 and located between an inner surface of the front sealing plate 300 and the internal terminal 123. As illustrated in FIGS. 11 and 12, the first O-ring 750 prevents insulating oil introduced into a space between the front sealing plate 300 and the bus bar frame 121 from leaking to the outside of the front sealing plate 300 through a space between an inner surface of the insulating oil hole 300a and the terminal spacer 730.

Also, the terminal assembly 700 may further include a second O-ring 760 located around the stud 720 press-fitted to the internal terminal 123 and exposed to a space between the internal terminal 123 and the bus bar frame 121, the second O-ring 760 being located between the internal terminal 123 and the bus bar frame 121. The second O-ring 760 prevents insulating oil introduced into a space between the front sealing plate 300 and the bus bar frame 121 from leaking to the outside of the front sealing plate 300 through a space between the internal terminal 123 and the stud 720 and a space between an inner surface of the terminal spacer 730 and the stud 720. The second of the pair of terminal assemblies 700 is arranged in a similar manner with respect to rear sealing plate 400.

As illustrated in FIGS. 1, 2, 5, and 6, the front end plate 500 covers the front sealing plate 300 and is fixed to the housing 200, and the rear end plate 600 covers the rear sealing plate 400 and is fixed to the housing 200.

The front end plate 500 includes a terminal exposing portion 500a configured to expose a connecting portion 711 of the external terminal 710 to the outside of the front end plate 500 and an inlet exposing portion 500b configured to expose the insulating oil inlet P1 to the outside of the front end plate 500. The rear end plate 600 includes an outlet exposing portion 600b configured to expose the insulating oil outlet P2 to the outside of the rear end plate 600.

When the front end plate 500 and the rear end plate 600 are applied to the battery module according to the present disclosure, a gasket for preventing leakage of insulating oil may be applied to each of a coupling portion between the front end plate 500 and the housing 200 and a coupling portion between the rear end plate 600 and the housing 200.

A battery pack and a vehicle according to an embodiment of the present disclosure include the battery module according to the present disclosure as described above. The battery pack includes at least one battery module and a pack housing in which the at least one battery module is accommodated. The battery module may be fastened to the pack housing through a fastening hole H formed in the front end plate 500 and/or the rear end plate 600. That is, a space where a fastening means such as a bolt for fastening between the battery module and the pack housing is inserted may be provided. When the battery pack according to the present disclosure includes a plurality of battery modules, the plurality of battery modules may be fastened to one another through the fastening hole H formed in the front end plate 500 and/or the rear end plate 600.

Although the embodiments of the present disclosure have been illustrated and described above, the present disclosure is not limited to the above-described specific embodiments. Various modified embodiments may be made by one of ordinary skill in the art without departing from the scope of the present disclosure as claimed in the claims.

What is claimed is:

1. A battery module comprising:
a sub-module comprising a cell stack comprising a plurality of battery cells and a plurality of cooling fins located between adj acent battery cells, a front bus bar frame assembly coupled to a first side of the cell stack in a longitudinal direction of the cell stack assembly, and a rear bus bar frame assembly coupled to a second side of the cell stack in the longitudinal direction of the cell stack, wherein the second side of the cell stack is opposite to the first side of the cell stack;
a housing accommodating the sub-module;
a front sealing plate covering an opening on a first side of the housing in a longitudinal direction of the housing and comprising an insulating oil inlet; and
a rear sealing plate covering an opening on a second side of the housing in the longitudinal direction of the housing and comprising an insulating oil outlet, wherein the second side of the housing is opposite to the first side of the housing.

2. The battery module of claim 1, wherein the-each of the plurality of cooling fins comprises:
a body contact portion located between adjacent battery cells; and
an edge cover portion bent at any one of an upper end and a lower end of the body contact portion to cover a corresponding edge of one of the adjacent battery cells.

3. The battery module of claim 2, wherein each of the front bus bar frame assembly and the rear bus bar frame assembly comprises a plurality of insulating oil holes formed at positions corresponding to insulating oil passages formed between the housing and an edge of the plurality of battery cells and between the edge cover portion and the edge of the plurality of battery cells.

4. The battery module of claim 3, wherein insulating oil introduced through the insulating oil inlet into the housing passes through the plurality of insulating oil holes formed in the front bus bar frame assembly and is introduced into the insulating oil passage.

5. The battery module of claim 4, wherein the insulating oil passing through the insulating oil passage passes through the plurality of insulating oil holes formed in the rear bus bar frame assembly, and is discharged from the housing through the insulating oil outlet.

6. The battery module of claim 2, wherein each of the front bus bar frame assembly and the rear bus bar frame assembly comprises a plurality of guide ribs formed at an upper end and a lower end of the front and rear bus bar frame assemblies and extending toward the cell stack.

7. The battery module of claim 6, wherein each of the plurality of cooling finsfurther comprises a pair of fixing portions, each of the pair of fixing portions having a shape corresponding to one of the plurality of guide ribs, formed on both end portions of the edge cover portion in a longitudinal direction of the edge cover portion, and each of the pair of fixing portions coupled to the respective guide rib.

8. The battery module of claim 1, further comprising front and rear terminal assemblies, wherein the front terminal assembly comprises an external front terminal located outside the front sealing plate, and a first stud passing through the front sealing plate and configured to electrically connect the external front terminal to the plurality of battery cells, and wherein the rear terminal assembly comprises an external rear terminal located outside the rear sealing plate, and a rear stud passing through the rear sealing plate and configured to electrically connect the external rear terminal to the plurality of battery cells.

9. The battery module of claim 8, wherein the front bus bar frame assembly comprises:
a front bus bar frame;
a plurality of bus bars fixed to the front bus bar frame, and connected to an electrode lead of the plurality of battery cells; and
a pair of internal terminals each fixed to the front bus bar frame, and connected to an electrode lead of the battery cell located at an outermost position from among the plurality of battery cells provided in the cell stack.

10. The battery module of claim 9, wherein the front sealing plate comprises a front terminal hole,
wherein the front terminal assembly further comprises a front terminal spacer inserted into the front terminal hole of the front sealing plate, and
wherein the front stud is fixed to the internal terminal and passes through the front terminal spacer.

11. The battery module of claim 10, wherein the front terminal assembly further comprises a front fastening nut fastened to the front stud passing through the front terminal spacer and the front external terminal and configured to fix the front external terminal to the front terminal spacer.

12. The battery module of claim 11, wherein the front terminal assembly further comprises a first front O-ring covering an outer circumferential surface of the front terminal spacer, wherein the first front O-ring is located between an inner surface of the front sealing plate and the internal terminal.

13. The battery module of claim 12, wherein the front stud is press-fitted by passing through the internal terminal, and
wherein the front terminal assembly further comprises a second front O-ring surrounding the front stud, and
wherein the second front O-ring is located between the internal terminal and the front bus bar frame.

14. A battery pack comprising the battery module according to claim 1.

15. A vehicle comprising the battery module according to claim 1.

16. The battery module of claim 8, wherein the rear bus bar frame assembly comprises:
a rear bus bar frame;
a plurality of bus bars fixed to the rear bus bar frame, and connected to an electrode lead of the plurality of battery cells; and
a pair of internal terminals each fixed to the rear bus bar frame, and connected to an electrode lead of the battery cell located at an outermost position from among the plurality of battery cells provided in the cell stack.

17. The battery module of claim 16, wherein the rear sealing plate comprises a rear terminal hole,
wherein the rear terminal assembly further comprises a rear terminal spacer inserted into the rear terminal hole of the rear sealing plate, and
wherein the rear stud is fixed to the internal terminal and passes through the rear terminal spacer.

18. The battery module of claim 17, wherein the rear terminal assembly further comprises a rear fastening nut fastened to the rear stud passing through the rear terminal spacer and the rear external terminal and configured to fix the rear external terminal to the rear terminal spacer.

19. The battery module of claim 18, wherein the rear terminal assembly further comprises a first rear O-ring covering an outer circumferential surface of the rear terminal spacer, wherein the first rear O-ring is located between an inner surface of the rear sealing plate and the internal terminal.

20. The battery module of claim 19, wherein the rear stud is press-fitted by passing through the internal terminal, and
wherein the rear terminal assembly further comprises a second rear O-ring surrounding the rear stud, and
wherein the second rear O-ring is located between the internal terminal and the rear bus bar frame.
